(19) United States
(12) Patent Application Publication
(10) Pub. No.: US 2015/0105871 A1
(43) Pub. Date: Apr. 16, 2015

(54) Method for Parametering a Field Device

(71) Applicant: Endress + Hauser Process Solutions AG, Reinach (CH)

(72) Inventor: Steffen Ochsenreither, Alberta (CA)

(21) Appl. No.: 14/385,543

(22) PCT Filed: Feb. 28, 2013
(86) PCT No.: PCT/EP2013/053983

§ 371 Date: Sep. 16, 2014

(30) Foreign Application Priority Data
Mar. 23, 2012 (DE) 10 2012 102 518.5

(51) Int. Cl. G05B 17/02

(52) U.S. Cl. CPC G05B 17/02
USPC 700/29

(57) ABSTRACT

A method for parametering a field device, wherein a field device has a parametering corresponding to a first device model and a first parameter set, wherein in the case, in which the field device is replaced by a substitute field device, a second parameter set corresponding to a second device model for parametering the substitute field device is transmitted to the substitute field device, wherein the second device model is derived from the first device model, and wherein the second device model and the second parameter set differ from the first device model and the first parameter set.

The present invention relates to a method for parametering a field device as well as to a computer program product.

In the technology of process automation, field devices are often applied, which serve for registering and/or influencing process variables. Such field devices include sensors, actuators and display and/or servicing devices. A large number of these devices are produced and sold by the applicant.

In a plant applying the technology of process automation, such field devices are often connected with one another and/or with a superordinated unit via a fieldbus. These superordinated units serve, for example, for process control, process visualizing and process monitoring. The superordinated unit can be, for example, a so-called gateway, which enables the accessing of the fieldbus by a remote service unit. On the other hand, the superordinated unit can also be a computer, in which an operating program, such as, for example, Fieldcare, is installed for servicing one or more field devices.

Since the failure of a field device of the fieldbus system can lead to a plant shutdown, it is of enormous importance for a plant operator that a replacement of the defective field device be performable as rapidly as possible. Thus it is known, for example, from Offenlegungsschrift DE 102009028655 A1 to replace a field device by a substitute field device of the same type by providing the replacement device with the same parametering as the field device originally integrated in the bus system. However, it cannot always be assured in the case of replacing a field device that the substitute field device can be operated with the same parametering. Especially, in the case of replacing a field device with a newer field device, which has, for example, a more up to date firmware, it can be the case that the originally applied parameter set is not suitable for operating the new field device.

It is, thus, an object of present invention to simplify the replacing of field devices, especially in the case of a so-called incompatible field device replacement, to assure maintaining the functional ability of the plant and to perform a parametering even in the case of an original parameter set incompatible with substitute field device.

The object according to the invention is achieved by a method for parametering a field device as well as by a computer program product.

As regards the method for parametering a field device, the object is achieved by a method for parametering a field device, wherein a field device has a parametering corresponding to a first device model and a first parameter set, wherein in the case, in which the field device is replaced by a substitute field device, a second parameter set corresponding to a second device model for parametering the substitute field device is transmitted to the substitute field device, wherein the second device model is derived from the first device model, and wherein the second device model and the second parameter set differ from the first device model and the first parameter set.

Furthermore, the object is achieved by a method for parametering a field device, wherein the field device has an identification, which designates a configuration of the field device, and has a parametering corresponding to a first device model and a first parameter set, wherein in the case, in which the identification of the field device changes, a second parameter set corresponding to a second device model for parametering the field device is transmitted to the field device, wherein the second device model is derived from the first device model, and wherein the second device model and the second parameter set differ from the first device model and the first parameter set.

For servicing field devices, especially for parametering and configuring (in the following referred to generally as “parametering”) field devices and/or for the read-out of parameter values from a field device, there is provided in a superordinated unit, as a rule, an operating program (operating, or servicing, tool) (e.g. FieldCare of Endress+Hauser). In parametering, especially parameters of the field device are set, respectively modified. The superordinated unit can, in such case, be connected directly to the fieldbus, on which the relevant field devices are connected, or to a superordinated communication network. Along with that, a field device can also be serviced by a servicing device, such as, for example, a portable personal computer (laptop), a portable handheld servicing device (handheld), a PDA (Personal Digital Assistant), etc., in which an operating program is implemented and which is connected, for example, to the fieldbus of the field device to be parametered.

Parametering of a field device occurs, as a rule, based on a field device model. The structure and the data content of a field device can be learned from the field device model.

For example, in the bus system, Profibus, individual parameters are addressed by giving the slot and index of the parameter. The association of slot and index to individual parameters is given, for example, in the “Device Description” (DD) and/or in the “Device Type Manager” (DTM), so that it is available to a superordinated unit or a servicing device. This parameter addressing system, referred to in the following as the field device model, can differ from the device-internal parameter addressing system. Device internally, the parameters are grouped into blocks (“BlockId”), thus, depending on their characteristics, to individual function blocks (e.g. function blocks “analog input” (AI) and/or “analog output” in the case of PROFIBUS and FOUNDATION Fieldbus), to components (e.g. electrical current supply, display, etc.), to a physical block, a transducer block, etc. Within the, blocks, the parameters are distinguished device-internally by parameter identifications (“ParameterId”). The device-internal parameter addressing system, especially the associating of the “BlockId” and the “ParameterId” to individual parameters, is determined, in such case, by the manufacturer of a field device.

The field device model serves, thus, for parametering a field device, for example, with a first parameter set. Exactly the device replacement of an old generation with a new generation of field devices is, however, in given cases, problematic. If the substitute field device is, for example, a field device of a newer generation, then a simple transferring of the old parameters is not directly possible, since the substitute field device, in given cases, has differently arranged function blocks, etc., which are no longer compatible with the originally utilized field device model. Especially, thus, the first parameter set cannot be used for parametering the substitute field device.

It is an idea of the present invention to derive the second device model from the first device model and, thus, to enable a parametering of the substitute device. An incompatibility can occur not only in the case of replacing a field device with another field device, but, instead, also, for example, in the case of updating the firmware of a field device.

It is thus another idea of the proposed invention to ascertain an identification characterizing the configuration of the field device, and in the case of determining that the identification of the field device has changed, to create a second device model. In the case of a change of this identification, it can, for example, be assumed therefrom, that changes have also occurred in the number and positions, i.e. the (field device-)internal addressing, of the field device parameters. According to a form of embodiment of the proposed invention, there is, thus, for example, furnished in a database a corresponding association, which gives, for which changes of the identification also changes of positions of the parameters, i.e. changes of the addressing, are present in the field device.

In an embodiment of the method, the first parameter set is downloaded from the field device and stored in a first database. Parametering of a field device can, in such case, also be updated multiple times and downloaded from the field, so that always a current parametering of the field device is available. If the field device is then, for example, replaced with a substitute field device or the identification of the field device changes, then this first parameter set is available, in order to produce a second parameter set corresponding to the second device model and to parameter the substitute field device, respectively the field device with the changed identification, corresponding to the second parameter set.

In an additional embodiment of the method, the first parameter set is stored in a first database and the mapping rules, based on which the second device model is derived from the first device model, are stored in a second database, which is preferably physically separated from the first database. Thus, a first database is available, in which (only) parameter sets are stored, while stored in a second database are the mapping rules, from which the second device model is derived from the first device model. Thus, it is, for example, possible to retrieve only the first parameter set from the first database, in order to parameter, for example, a substitute field device whose parametering is compatible with that of the field device to be replaced. In order to detect compatibility between parameter sets and field devices, corresponding information, for example, in the form of the above-mentioned associations, can likewise be stored in the first database. Based on these associations, it can then be ascertained, whether the mapping rules from the second database and thus the second device model are required, in order to parameter the substitute field device or the field device with the changed identification.

In an additional embodiment of the method, based on the identification of the field device and/or a substitute field device identification, which designates a configuration of the substitute field device, the mapping rules and/or the second parameter set are/is ascertained. Especially, based on the identification of the field device, respectively of the substitute field device, the first parameter set and the mapping rules can be downloaded from the first, respectively second, database.

In an additional embodiment of the method, the second parameter set and/or the second device model are/is determined from the first parameter set and/or the first device model based on manufacturer details from the manufacturer of the field device, respectively of the substitute field device. The determining of the second device model from the first device model can involve, for example, a pure supplementation of the first device model or a replacement of elements of the first device model.

In an embodiment of the method, the field device, respectively the substitute field device, is connected with a fieldbus, via which fieldbus parametering of the field device, respectively of the substitute field device, is performed from a superordinated unit. In this way, also, for example, the first parameter set can be downloaded from the field device and/or the second parameter set transmitted to the field device, respectively to the substitute field device.

In an additional embodiment of the method, in the case of replacing of the field device with the substitute field device or in the case of a change of the identification of the field device, the second parameter set is transmitted from the superordinated unit via the fieldbus to the substitute field device, respectively to the field device with the changed identification. The transmission of the second parameter set can, in such case, occur automatically. To this end, for example, the superordinated unit can correspondingly retrieve a fieldbus address at regular intervals. Through this retrieval, it can be detected, whether the field device accessible at this address was replaced, i.e. is a substitute field device or the identification of the field device has changed.

In an additional form of embodiment of the method, the field device has a fieldbus address and the substitute field device is provided with the same fieldbus address as the field device, when it is connected to the fieldbus. Thus, the field device as well as the substitute field device, respectively the field device with the changed identification, have the same fieldbus address, with which it can communicate via the fieldbus. The fieldbus address of the substitute field device, respectively of the field device with the changed identification, can be set, for example, upon the connecting of the field device, respectively the substitute field device, to the fieldbus. Known from the state of the art are, for example, DIP switches, via which the fieldbus address of a field device can be set.

In a form of embodiment of the method, the configuration of the field device concerns a software- and/or hardware configuration of the field device or components of the field device. Since this configuration, for example, is processed and/or reflected in the identification of the field device, the software version, such as, for example, the version of the firmware, of the field device can be ascertained, for example, by a retrieval of the identification by the superordinated unit. Furthermore, also the hardware configuration of the field device can be ascertained thereby, for example, by corresponding identification numbers.

In a form of embodiment of the method, the device model concerns a field device internal addressing of the parameters of the field device, preferably according to a so-called slot and a so-called index, wherein the first and second device models according to this addressing differ from one another. If, for example, a parameter corresponding to the first device model was assigned a first slot and a first index, then the same parameter corresponding to the second device model can be assigned a second slot and a second index, which second slot and second index differ from the first slot and the first index. This associating of the first slot and the second slot as well as the first index and the second index can occur based on the mapping rules, which are furnished in the second database.

The addressing of the parameters can occur in the superordinated unit; a fieldbus access unit, i.e. a Master Class 2, such as, for example, a gateway, serves for placing this parametering on the fieldbus. The superordinated unit, in which, for example, an operating program such as Fieldcare is installed and/or executed, should perform the associating of the addressings. This is also referred to as mapping. Another option is that this mapping is thereafter stored in the database. Thus, a mapping database could then grow over time and one would not perform a new mapping each time for a field device replacement and like changes of the identification of a fieldbus address.

In an additional form of embodiment of the method, the identification of the field device addressable with a fieldbus address is queried by the superordinated unit via the fieldbus and this identification compared with an identification previously downloaded from this fieldbus address. This can, for example, have been at regular intervals or be initiated by user input.

The object is, furthermore, achieved by a computer program product with program code means for performing the method according to one of the above described embodiments.

The invention will now be explained in greater detail based on the appended drawing, the figures of which show as follows:

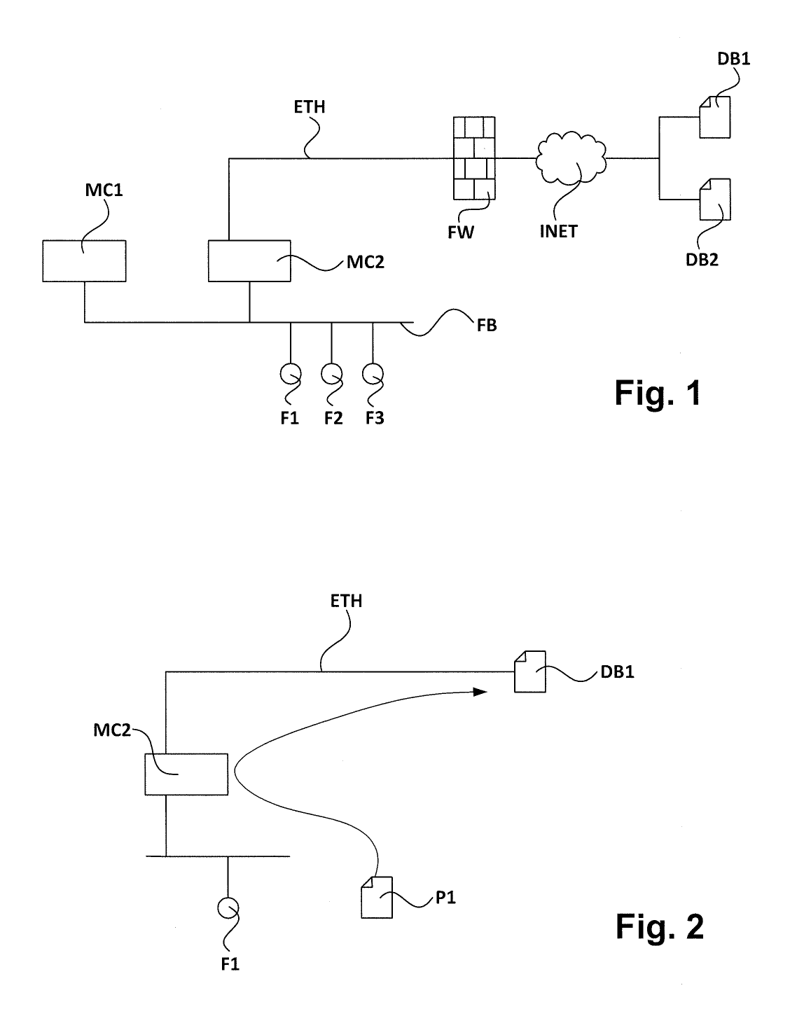

FIG. 1 a schematic representation of a plant utilizing process automation technology, wherein field devices are connected with a superordinated unit via a fieldbus,

FIG. 2 a schematic representation of transmission of a first parameter set from a field device into a first database,

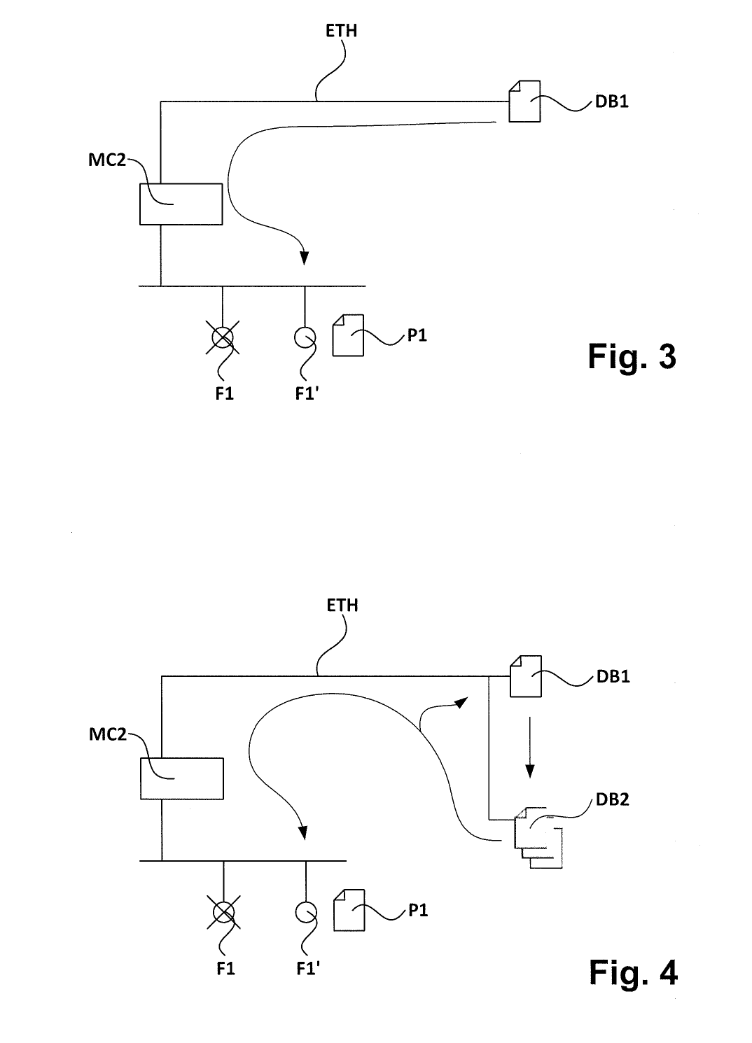

FIG. 3 a schematic representation of transmission of the first parameter set from the first database to a substitute field device, and

FIG. 4 a schematic representation of transmission of a second parameter set to a substitute field device, which second parameter set was derived from the first parameter set and the first device model.

FIG. 1 shows a schematic representation of the topology of a plant of automation technology, wherein the plant is connected with a superordinated unit via a data bus ETH, in this case, an Ethernet-connection and the Internet INET.

The fieldbus FB, via which the field devices F1, F2, F3 are connected with one another, can be, for example, a PROFIBUS, a FOUNDATION Fieldbus or a HART fieldbus. Besides the field devices F1, F2, F3, a so-called Master Class 1 MC1 and a Master Class 2 MC2 are connected to the fieldbus FB. The Master Class 1 MC1 is, for example, the control unit, which serves for control of the process running in the plant. The Master Class 2 MC2 is a so-called gateway, which enables communication of the superordinated unit, not explicitly shown, via the fieldbus FB and with the field devices F1, F2, F3. The superordinated unit is, for example, a computer, which is connected via the Internet INET with the superordinated data bus ETH and the gateway MC2 as well as with the fieldbus FB. Accessing of the first and second databases DB1, DB2 can occur via the superordinated unit, wherein the first database DB1 serves for storing at least one parameter set, respectively a plurality of parameter sets, and the second database DB2 for storing the mapping rules, from which the second device model can be derived from the first device model. The first database DB1 and/or the second database DB2 can be a logical and/or a physical database. The first database DB1 can, in such case, be logically and/or physically isolated from the second database DB2. The first and second databases DB1, DB2 can, in such case, be a component of a (single) computer or plurality of computers connected with one another. The superordinated data bus ETH can be separated from the Internet, for example, by a so-called firewall FW.

FIG. 2 shows a section of a schematic representation of a plant of process automation technology according to FIG. 1. Furthermore, the transmission of the parameter set P1 stored in the field device F1 into the first database DB1 is shown in FIG. 2 schematically by means of an arrow. Field device F1 includes a firmware, which, by way of example, is referred to with the first version number 1.00. Furthermore, the field device F1 has a serial number referred to, by way of example, with XX. Both the parameter set P1 as well as also the firmware 1.00 and the serial number XX are transmitted to the superordinated unit, and the superordinated unit stores the firmware, respectively its version number 1.00, the serial number XX as well as also the parameter set P1 in the first database DB1. The transmission of the identification composed of serial number XX and firmware, respectively version number 1.00 and/or transmission of the first parameter set P1 occurs, in such case, from the field device F1 via the fieldbus FB and the gateway MC2 as well as via the superordinated data bus ETH to the superordinated unit, respectively to the first database DB1. This transmission can occur and be repeated, for example, at a defined time interval for all of the field devices F1, F2, F3 connected to the fieldbus FB or only for a part of the field devices connected to the fieldbus FB. The transmission can also be initiated, for example, manually by a user of the superordinated unit. In this way, always the newest state of the configuration of one of the field devices F1, F2, F3 is registered in the database DB1. If it is, for example, ascertained that the identification of a field device has changed in comparison to a previously ascertained identification, then an adjustment parametering can be performed.

FIG. 3 shows the schematic representation of replacing a field device F1 with a substitute field device F1′. In such case, the first parameter set P1 stored in the superordinated unit, respectively in the first database DB1, is transmitted to the substitute field device. This procedure is shown schematically in FIG. 3 by an arrow. The transmission can be triggered by a change of the identification associated with a fieldbus address. If the identification differs from a previously stored identification, then in a second step it is determined whether the substitute field device F1′ is compatible with the field device F1 originally installed at the bus address. The terminology, compatible, means whether the first parameter set P1 and/or the first device model can be used likewise for operating, especially for parametering, the substitute field device F1′. In the example of an embodiment according to FIG. 3, the substitute field device F1′ does, indeed, have a different serial number, by way of example, referenced with XY, however, the firmware version of the substitute field device F1′, with the version number 1.00, is identical with that of the replaced field device F1. The first parameter set P1 can, consequently, be used also for operating the substitute field device F1′. The first parameter set P1 according to the first device model can, thus, be transmitted to the substitute field device F1′. Since the field device F1 to be replaced and the substitute field device F1′ can use the same fieldbus address, a corresponding telegram, respectively telegrams, can be addressed to this fieldbus address.

FIG. 4 shows a schematic representation of a plant of process automation technology according to FIG. 1, in the case of which a field device F1 is replaced by a substitute field device F1′. Corresponding to the form of embodiment in FIG. 3, the identification of the substitute field device F1′ is compared with the identification of the field device F1 previously installed at the fieldbus address. The substitute field device F1′ has a firmware with the version number 2.00, which differs from the firmware with the version number 1.00. Due to the different firmware versions, the first parameter set P1, which is stored in the first database DB1, cannot be directly used for parametering the substitute field device F1′. It is rather necessary to supplement or change the first parameter set P1 and, thus, to produce a second parameter set P2, which can be used for parametering the substitute field device F1′.

In the case of a change of the firmware of a field device, there can be a change of the parameters associated with a certain address. In order to take these changes into consideration, it is necessary to adapt the first device model and to create a second device model. This adapting can occur using the mapping rules furnished in the second database DB2. Through these mapping rules, for example, the slot and index associated with a parameter can change in such a manner that it shows in the address, with which the parameter is queryable or furnished in the newer firmware version in the field device.

### LIST OF REFERENCE CHARACTERS

F1 field device
F1′ substitute field device
F2 field device
F3 field device
MC1 Master Class 1
MC2 Master Class 2
FB fieldbus
ETH Ethernet
FW firewall
INET Internet
DB1 first database
DB2 second database
P1 first parameter set
P2 second parameter set

1-14. (canceled)

15. A method for parametering a field device comprising the steps of:
a field device with a parametering corresponding to a first device model and a first parameter set; and
in the case, in which the field device is replaced by a substitute field device, a second parameter set corresponding to a second device model for parametering the substitute field device is transmitted to the substitute field device; wherein:
the second device model is derived from the first device model; and
the second device model and the second parameter set differ from the first device model and the first parameter set.

16. A method for parametering a field device, wherein:
the field device has an identification, which designates a configuration of the field device, and has a parametering corresponding to a first device model and a first parameter set;
in the case, in which the identification of the field device changes, a second parameter set corresponding to a second device model for parametering the field device is transmitted to the field device;
the second device model is derived from the first device model; and
the second device model and the second parameter set differ from the first device model and the first parameter set.

17. The method as claimed in claim 15, wherein:
the first parameter set is downloaded from the field device and stored in a first database;
the first parameter set is preferably downloaded from the field device, before the field device is replaced by the substitute field device, respectively before the identification of the field device changes.

18. The method as claimed in claim 15, wherein:
the first parameter set is stored in a first database and mapping rules, based on which the second device model is derived from the first device model, are stored in a second database, which is preferably physically independent from the first database.

19. The method as claimed in claim 18, wherein:
based on the identification of the field device and/or an identification of the substitute field device, which identification designates a configuration of the substitute field device, the mapping rules and/or the second parameter set are/is ascertained; especially, based on the identification of the field device, respectively of the substitute field device; and
the first parameter set and the mapping rules are downloaded from the first, respectively second database.

20. The method as claimed in claim 15, wherein:
the second parameter set and/or the second device model are determined from the first parameter set and/or the first device model based on manufacturer details from the manufacturer of the field device, respectively of the substitute field device.

21. The method as claimed in claim 15, wherein:
the field device, respectively the replacement-field device, is connected with a fieldbus, via which fieldbus parametering of the field device, respectively of the substitute field device is performed from a superordinated unit.

22. The method as claimed in claim 21, wherein:
in the case of replacing of the field device with the substitute field device or in the case of a change of the identification of the field device, the second parameter set is transmitted from the superordinated unit via the fieldbus to the substitute field device, respectively to the field device.

23. The method as claimed in claim 21, wherein:
the field device has a fieldbus address; and
the substitute field device is provided with the same fieldbus address as the field device, when it is connected to the fieldbus.

24. The method as claimed in claim 15, wherein:
the configuration of the field device concerns a hardware- and/or software configuration of the field device or components of the field device.

25. The method as claimed in claim 15, wherein:
a device model concerns a field device internal addressing of the parameter of the field device, preferably according to a so-called slot and a so-called index, wherein the first and second device models according to this addressing differ from one another.

26. The method as claimed in claim 15, wherein:
based on the furnished mapping rules, a slot of the first device model is mapped to a slot of the second device model and/or an index of the first device model is mapped to an index of the second device model.

27. The method as claimed in claim 15, wherein:
the superordinated unit via the fieldbus queries the identification of a field device addressable at a fieldbus address, and this identification is compared with an identification previously downloaded from this fieldbus address.

28. A computer program product with program code means for performing a method as claimed in claim 15.
